(19) United States
(12) Patent Application Publication
(10) Pub. No.: US 2008/0311889 A1
(43) Pub. Date: Dec. 18, 2008

(54) PORTABLE COMMUNICATION DEVICE AND METHOD FOR SHARING A USER PERSONALITY

(75) Inventors: Gregory A. Dunko, Cary, NC (US); Kurt Schmidt, Chapel Hill, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/762,267

(22) Filed: Jun. 13, 2007

(51) Int. Cl. H04M 3/42

(52) U.S. Cl. 455/414.1; 455/418

(57) ABSTRACT

A portable communication device is equipped with a personality profile application that facilitates creation and sharing of a user personality profile that is based on user activities and user preferences involving the portable communication device. The personality profile may be shared with third parties, thereby allowing a third party to experience their portable communication device though the “lens” of the personality creator.

### TECHNICAL FIELD OF THE INVENTION

The present invention relates generally to portable communication devices, and, more particularly, to a portable communication device and method of creating and/or sharing a user personality.

### DESCRIPTION OF RELATED ART

In recent years, portable communication devices, such as mobile phones, personal digital assistants, mobile terminals, etc., continue to grow in popularity. As the popularity of portable communication devices continues to grow, today's wireless landscape is rapidly changing as mobile phones and networks are being enhanced to provide features and services beyond voice communications. The wireless industry is experiencing a rapid expansion of mobile data services. In addition, the features associated with certain types of portable communication devices have become increasingly diverse. To name a few examples, many portable communication devices have cameras, text and multimedia messaging capability, Internet browsing functionality, electronic mail capability, video playback capability, audio playback capability, image display capability, position sensing capability and hands-free headset interfaces.

With the rapid expansion of portable communication device functionality, users continue to make use of their portable communication devices for more and more activities, e.g., electronic mail communication, Internet browsing, music and video downloading and playback and the like. With many of these activities, the portable communication device may be configured to accept and store the user's preferences and/or profiles associated with each activity.

### SUMMARY

In view of the foregoing, a need exists for additional mobile data services, and application programs for providing additional mobile data services, such as a personality profile application program that facilitates creation and sharing a user's personality profile with other portable communication devices.

One aspect of the technology relates to a portable communication device including a memory and a controller coupled to the memory, wherein the controller executes a personality profile application program stored on a machine-readable medium. When the personality profile application program is loaded in memory in the portable communication device and executed, the program causes the portable communication device to create a user personality profile based on user activities and user preferences involving the portable communication device and to transmit the user personality profile to a remote location.

According to another aspect, the remote location is a third-party portable communication device.

According to another aspect, the user personality profile is configured to affect searching and/or sorting functionality associated with the third-party portable communication device.

According to another aspect, the portable communication device receives files indicative of third party personality profiles.

According to another aspect, the personality profile application program causes the portable communication device to create a group personality profile based on the received third-party personality profiles and the user personality profile.

According to another aspect, the group personality profile includes mood adjustability.

According to another aspect, when the portable communication device receives input indicative of mood, the personality profile application causes the portable communication device to adjust at least one attribute of the group personality profile based on the received mood input.

According to another aspect, the personality profile application causes the portable communication device to create the personality profile by tracking user activities based on the user's use of the portable communication device, wherein the user activities include (i) places visited by the user, (ii) events attended by the user, (iii) networks to which the user has connected via the portable communication device, and/or (iv) devices to which the user has connected via the portable communication device.

According to another aspect, tracking a user activity includes determining a location of an activity and/or a time and/or date of an activity

According to another aspect, a location of an activity is determined using a position determination device coupled to the portable communication device.

According to another aspect, the personality profile application causes the portable communication device to create the personality profile by tracking user preferences based on the user's use of the portable communication device, wherein the user preferences include (i) multimedia preferences, (ii) media playback preferences, (iii) menu settings, (iv) display settings, and/or (v) websites visited using the portable communication device.

According to another aspect, the portable communication device is a mobile telephone.

Another aspect of the technology relates to a method of user personality profile management implemented on a portable communication device that includes creating a user personality profile based on user activities and user preferences involving use of the portable communication device; and sharing the user personality profile with a third party.

According to another aspect, the user personality profile is configured to affect searching and/or sorting functionality associated with the third-party portable communication device.

According to another aspect, the method includes receiving one or more files indicative of third-party personality profiles.

According to another aspect, the method includes creating a group personality profile based on the received third-party personality profiles and the user personality profile.

According to another aspect, the user personality profile includes mood adjustability, whereby at least one property of the user personality profile is adjusted based on received mood input.

Another aspect of the technology relates to a method of managing a user personality profile implemented on a portable communication device that includes receiving a third-party personality profile; receiving user input indicative of a search request or a sort request; initiating a search and/or sort based on the received third-party personality profile; and presenting search and/or sort results to a user of the portable communication device based on the third-party personality profile.

Another aspect of the technology relates to a method of enhancing use of a portable communication device that includes creating a celebrity personality profile indicative of the celebrity's activities and the celebrity's preferences involving a portable communication device; and offering the celebrity personality profile for purchase.

According to another aspect, the method includes uploading the celebrity personality profile to a requesting portable communication device.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of a communications system including a portable communication device on which aspects of the technology may be carried out;

FIG. 2 is a diagrammatic illustration of a portable communication device in accordance with aspects of the technology;

FIG. 3 is a flow chart or functional diagram representing a method of managing a user personality profile implemented on a portable communication device;

FIG. 4 is a flow chart or functional diagram representing a method of portable communication device operation based on a borrowed user personality profile;

FIG. 5 is a flow chart or functional diagram representing relevant operation between two portable communication devices in managing a user personality profile;

FIG. 6 is a flow chart or functional diagram representing a method of managing a user personality profile implemented on a portable communication device; and

FIG. 7 is a flow chart or functional diagram representing a method of commercial operation involving a celebrity personality profile operable on a portable communication device.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

The present disclosure describes a portable communication device that is equipped with a personality profile application that facilitates creation and sharing of a user personality profile. The user personality profile may be created based on automatic, semi-automatic and/or manual tracking of user activities and user preferences involving the user's portable communication device. The personality profile may be shared with third parties, thereby allowing a third party to experience their portable communication device through the “lens” of the personality creator.

As used herein, the term “portable communication device” includes portable radio communication equipment. The term “portable radio communication equipment,” which may be referred to below as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), gaming devices with wireless connections, or the like. While the present invention is being discussed with respect to portable communication devices, it is to be appreciated that the invention is not intended to be limited to portable communication devices, and can be applied to any type of electronic equipment that have configurable settings and/or preferences and that are capable of being used for voice and/or data communication.

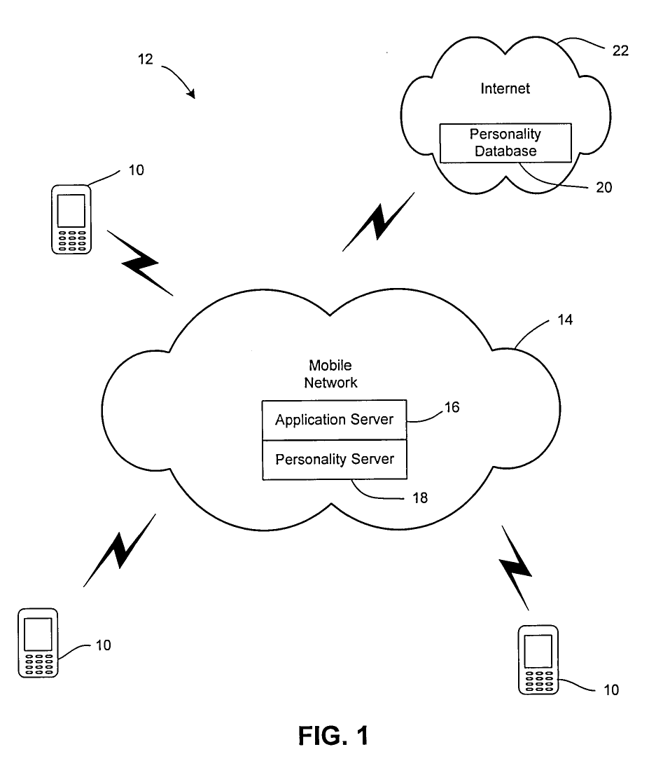

Referring initially to FIG. 1, a portable communication device 10 may be configured to operate as part of a communication system 12. The communication system 12 includes a mobile network 14, such as a mobile cellular telephony network, that facilitates communication, such as voice communication and/or data transfer between a plurality of portable communication devices 10, such as mobile phones, mobile terminals or the like. The mobile network 14 includes one or more servers (referred to generally as application server 16) for managing calls placed by and destined to the portable communication device 10, as well as supporting one or more applications (e.g., a personality profile application) by (e.g., including appropriate hardware and/or application programs for generating, transmitting and receiving personality profiles). In the illustrated embodiment, the mobile network 14 also includes or is otherwise able to communicate with a personality server 18, which is operable to interact with one or more portable communication devices 10 (e.g., by uploading and downloading personality profiles) to facilitate personality profile sharing between respective portable communication devices.

For purposes of the present discussion, the portable communication device 10 will be described with respect to creating, sharing and/or receiving user personality profiles, and modifying portable communication device operations, e.g., searching, sorting and the like, based on created and/or shared personality profiles. In accordance with at least one embodiment, the portable communication device 10 may engage in the purchase and/or downloading of “celebrity personality profiles” from a suitable personality database or server 20 accessible via the Internet 22.

It will be appreciated that the mobile network 14 includes a network infrastructure, portions of which are used or otherwise accessed by the portable communication devices. The portable communication devices 10 may interact with each other and/or the network infrastructure in accordance with any suitable communication standard, including, but not limited to, Advanced Mobile Phone Service (AMPS), Digital Advanced Mobile Phone Service (D-AMPS), General Packet Radio Service (GPRS), Universal Mobile Telecommunications System (UMTS), Global System for Mobile Communications (GSM), Code Division Multiple Access (CDMA), Worldwide Interoperability for Microwave Access (WiMax), Voice-Over IP (VoIP), Session Initiated Protocol (SIP), Wireless Local Area Network (WLAN) or the like. In other words, the communication system shown in FIG. 1 is provided for purposes of explaining aspects of the present invention, without limiting the invention to a particular communication system design, architecture or communication standard. Further aspects of the invention may be employed in the connection with device-to-device exchanges (wired, wireless or via intermediary).

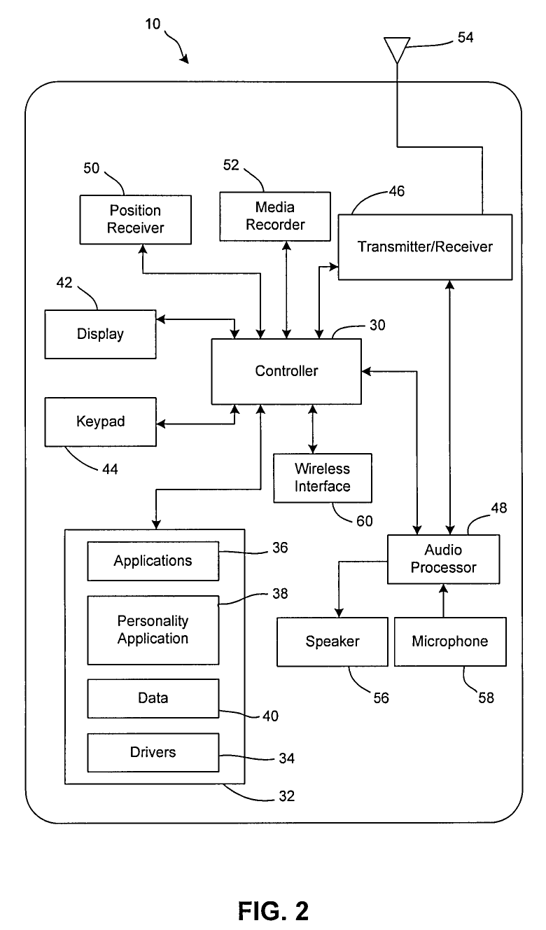

FIG. 2 represents a functional block diagram of a portable communication device 10. The portable communication device 10 includes a controller 30 that controls the overall operation of the portable communication device. The controller 30 may include any commercially available or custom microprocessor or microcontroller. Memory 32 is operatively connected to the controller 30 for storing control programs and data used by the portable communication device. The memory 32 is representative of the overall hierarchy of memory devices containing software and data used to implement the functionality of the portable communication device in accordance with one or more aspects described herein. The memory 32 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as text messages (also known as short message service or SMS), electronic mail messages, multimedia messages (also known as MMS), image files, video files, audio files, ring tones, streaming audio, streaming video, data feeds (e.g., podcasts) and so forth.

In the illustrated embodiment, memory 32 stores drivers 34 (e.g., I/O device drivers), application programs 36, including a personality profile application program 38 (also referred to as a as a personality application), and application program data 40 (e.g., personality profiles created and/or received by the portable communication device). The I/O device drivers include software routines that are accessed through the controller 30 (or by an operating system (not shown) stored in memory 32) by the application programs, including the personality profile application program 38, to communicate with devices such as a display 42 and keypad 44 (e.g., a standard keypad, a QWERT keypad or a touch screen keypad) as well as other input/output ports.

The application programs, including the personality profile application program 38, comprise programs that implement various features of the portable communication device 10, such as voice calls, e-mail, Internet access, multimedia messaging, contact manager and the like. As is described more fully below, the personality profile application program 38 comprises a program, logic routine or code that enables the user to create, share and/or receive personality profiles that are based on a user's activities and/or preferences involving the user's portable communication device.

A person having ordinary skill in the art of computer programming, and specifically in applications programming for mobile phones, will consider it obvious in view of the provided description how to program a mobile phone to operate and carry out the functions described herein with respect to the personality profile application 38 (and any interfacing between the personality profile application 38 and other application programs (e.g., messaging application programs, such as a universal messenger program, media application programs and the like). Accordingly, details as to the specific programming code have been left out. Also, while the media-enhanced messaging functionality may be carried out via the controller 30 and media-enhanced messaging application 38 (alone or in conjunction with other application programs) in memory 32 in accordance with inventive aspects, such function also could be carried out via dedicated hardware, firmware, software or combinations thereof without departing from the scope of the present invention.

With continued reference to FIG. 2, the controller 30 interfaces with the aforementioned display 42 and keypad 44 (and any other user interface device(s)), a transmitter/receiver 46 (often referred to as a transceiver), audio processing circuitry, such as an audio processor 48, and a position determination element or position receiver 50, such as a global positioning system (GPS) receiver. The portable communication device 10 may include a media recorder 52 (e.g., a still camera, a video camera, an audio recorder or the like) that captures digital pictures, audio and/or video. Image, audio and/or video files corresponding to the pictures, songs and/or video may be stored in memory 32 (e.g., in the case of music or video files, in a local media content database, metadata or other information associated with which may be used in the creation and/or modification of a personality profile).

An antenna 54 is coupled to the transmitter/receiver 46 such that the transmitter/receiver 46 transmits and receives signals via antenna 46, as is conventional. The portable communication device includes an audio processor 48 for processing the audio signals transmitted by and received from the transmitter/receiver. Coupled to the audio processor 48 are a speaker 56 and microphone 58, which enable a user to listen and speak via the portable communication device. Audio data may be passed to the audio processor 48 for playback to the user. The audio data may include, for example, audio data from an audio file stored in the memory 32 and retrieved by the controller 30 or audio data associated with a generated or received media-enhanced text message. The audio processor 48 may include any appropriate buffers, decoders, amplifiers and the like.

The portable communication device also may include one or more local wireless interfaces (indicated generally as wireless interface 60), such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, or any other electronic device. Also, wireless interface 60 may be representative of an interface suitable for communication within a cellular network or other wireless wide-area network (WWAN).

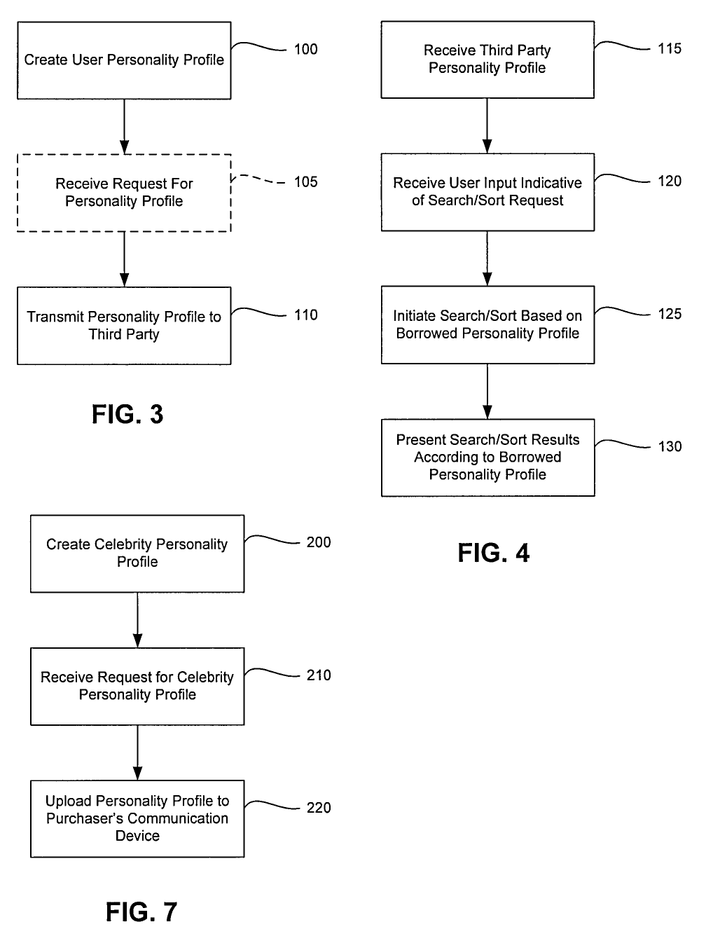

While for purposes of simplicity of explanation, the flow charts or functional diagrams in FIGS. 3-7 include a series of steps or functional blocks that represent one or more aspects of the relevant operation of the portable communication device 10. It is to be understood and appreciated that aspects of the invention described herein are not limited to the order of steps or functional blocks, as some steps or functional blocks may, in accordance with aspects of the present invention occur in different orders and/or concurrently with other steps or functional blocks from that shown or described herein. Moreover, not all illustrated steps or functional blocks of aspects of relevant operation may be required to implement a methodology in accordance with an aspect of the invention. Furthermore, additional steps or functional blocks representative of aspects of relevant operation may be added without departing from the scope of the present invention.

The methodologies illustrated in FIGS. 3-7, which are implemented on or through a portable communication device, relate to methods of creating, sharing, receiving, and/or managing user personality profiles. Turning now to FIG. 3, a method of managing a user personality profile begins at functional block 100 where the portable communication device creates a user personality profile. The user personality profile may be created based on user activities and/or user preferences involving the portable communication device. As is described more fully below, user activities may include, but are not limited to, messages sent, places or locations visited, events attended, devices and/or networks to which the portable communication device connects, specific dates or activities and the like.

In addition, user preferences may include, but are not limited to, websites visited by the user of the portable communication device, e.g., using the portable communication device to access the Internet, contacts, e.g., phone contacts, mail contacts, and the like, stored within the user preferences portion of the portable communication device, music played through or otherwise stored on the portable communication device, podcast stations, portable recording and playback device settings, e.g., TiVo® settings, Internet content preferences, streaming media content preferences and the like, and other settings such as theme or user-entered search criteria, priorities or the like. It will be appreciated that aspects of the invention are not limited to a certain number or nature of user activities and/or user preferences. Moreover, as portable communication devices continue to evolve in terms of functionality and memory capacity, more and more user activities and/or user preferences may be tracked or otherwise incorporated into a user personality profile.

Creation of the user personality profile may be carried out automatically, e.g., by the portable communication device automatically tracking user activities and/or user preferences, semi-automatically, e.g., by a combination of the portable communication device automatically tracking user activities and/or user devices in combination with the user manually entering information relating to user activities and/or user preferences, and/or manually, e.g., by the user manually entering information related to user activities and/or user preferences. It will be appreciated that a user personality profile may be used or otherwise accessed by the user's portable communication device for a number of purposes, such as sorting of media, playback of media and the like on the portable communication device, establishing menu settings, music settings, rendering settings, operational settings, e.g., settings related to how the device should operation in certain scenarios, and other settings, and searching for content on the Internet. It will be appreciated that the present invention is not limited to any particular methodology or algorithm for creation of the user personality profile.

The portable communication device can be equipped to obtain location information in a variety of ways. Location may be determined by the device itself, provided from the network, determined through coordination between the device and the network, or may be entered manually by the user. For example, location information may be determined by receipt of location data from a dedicated system, such as a global positioning satellite (GPS), Galileo satellite system or the like. Such data may be received via a suitable position receiver 50, e.g., a GPS receiver.

Optionally, at functional block 105, the user's portable communication device may receive a personality profile request, e.g., a request from a third party through his/her portable communication device to grant him/her access to the user's personality profile so that the third party may download the user's personality profile and have an experience with his/her personal communication device through the “lens” of the personality creator. At functional block 110, the portable communication device transmits the personality profile to the requesting third party, e.g., via any suitable data transfer mechanism.

Referring now to FIG. 4, a method of portable communication device operation based on a received or “borrowed” third party personality profile begins at functional block 115, where a user receives via his/her portable communication device a third party personality profile. As is discussed above with reference to FIG. 3, the third party personality profile may be created automatically, semi-automatically, and/or manually and may be based on or otherwise indicative of the third party's activities and/or preferences involving his/her portable communication device.

At functional block 120, the portable communication device receives user input indicative of a search and/or sort request. For example, the user may enter input requesting an Internet search, a search for audio or music files, a search for video files or the like based on certain search criteria. Alternatively, the user may enter input indicative of a sort request, e.g., a request to sort results from a prior search based on certain sort criteria.

At functional block 125, the portable communication device initiates a search and/or sort (at least in part) based on the borrowed personality profile. In one embodiment where a search is initiated, the search may be initiated based on a combination of user input, e.g., input looking for a particular type of media, for example, by artist or title, together with preferences or other attributes associated with the borrowed personality profile. Alternatively, the portable communication device may initiate a general search, e.g., a search for music or other media content, solely on the basis of any attributes and/or preferences associated with the borrowed personality profile.

At functional block 130, the portable communication device may present the search and/or sort results according to attributes and/or preferences associated with the borrowed personality profile. For example, if the borrowed personality profile has a preference for country music, the search and/sort results may be presented with country music songs listed above other types of music. As another example, the borrowed personality profile may include a preference for certain display features, e.g., fonts, font color, graphical embellishments and the like, which would be reflected in the search and/or sort results returned by the portable communication device. Of course, it will be appreciated that many other modifications and/or parameters associated with search and/or sort requests, as well as results of the search and/or sort request, may be involved in accordance with the borrowed personality profile.

Stated differently, the sharing of the personality profile may allow the “borrowing user” to have an experience with his/her own portable communication device through the “lens” of the personality creator. The borrower user's portable communication device and associated content may be presented/rendered with a unique personality. In addition, the searches would return results based on parameters or attributes associated with the borrowed personality.

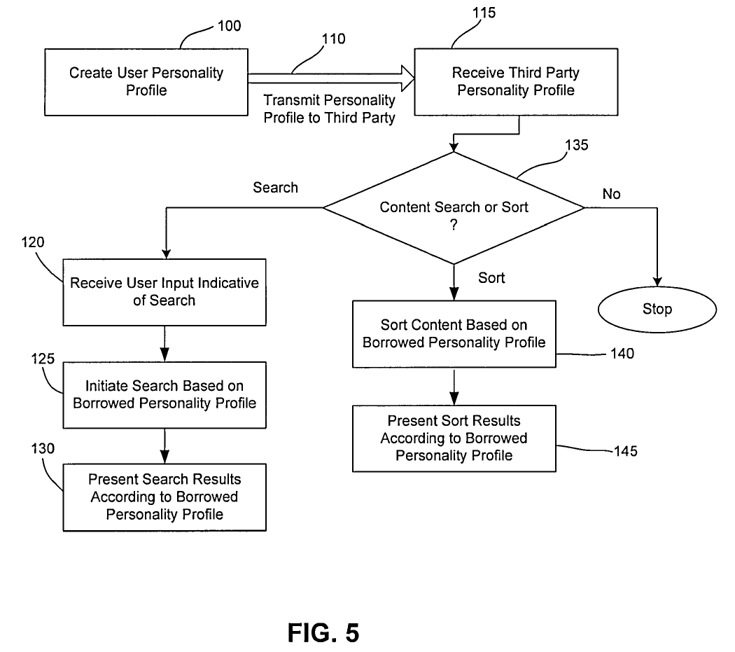

Turning now to FIG. 5, where like elements have like reference numerals with respect to the functional blocks depicted in FIG. 3 and FIG. 4, another embodiment of portable communication device operation associated with the creation, sharing, and/or receipt of personality profile begins at functional block 100, where the portable communication device of the personality creator creates a user personality profile based on user activities and/or user preferences along the lines discussed more fully above with respect to FIG. 3. At functional block 110, the personality profile is transmitted to a third party. At functional block 115, the third party receives the personality profile and incorporates the received or borrowed personality profile for use with various portable communication device operations, such as searching and sorting.

At functional block 135, the borrower's portable communication device is operative to receive input indicative of various operations, including searching and sorting. Of course, if no input is received, the borrower's portable communication device will take no action with respect to searching and/or sorting. However, at functional block 120, the borrower's portable communication device may receive user input indicative of a search. At functional block 125, the borrower's portable communication device may initiate one or more searches based on the borrowed personality profile. As is discussed above with reference to FIG. 4, the search may be initiated solely on the basis of preferences within the borrowed personality profile. At functional block 130, the search results are presented or otherwise rendered to the borrower according to the attributes contained within the borrowed personality profile.

Similarly, if the borrower's portable communication device receives input requesting a sort of any type of any information, e.g., media content returned from a previous search for media content (songs, video clips or the like), search results from an Internet search or the like, the borrower's portable communication device may sort the content based on the profile attributes within the borrowed personality profile. At functional block 145, the sort results may be presented or otherwise rendered to the borrower according to attributes contained within the borrowed personality profile. It will be appreciated that the personality profiles may include rules and/or instructions indicative of preferences involving, for example, sorting of media, playback of media, establishing menu settings, music settings, rendering settings or other settings, and searching for content on remote databases, such as on the Internet. The personality profile rules may include rules for device operation based on metadata associated with various media content files and the like.

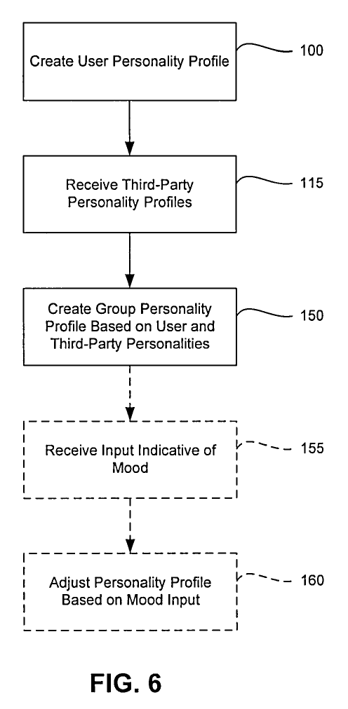

Referring now to FIG. 6, a method of creating and/or managing a user personality profile begins at functional block 100 where the portable communication device creates a user personality profile. As is discussed more fully above, the user personality profile may be created automatically, semi-automatically and/or manually based on user activities and/or user preferences involving the portable communication device. At functional block 115, the portable communication device may receive one or more third-party personality profiles from other portable communication devices.

At functional block 150, the portable communication device may create a group personality profile based on the created user personality profile and any received third-party profile(s). The group's personality profile may be created in one of a variety of ways, such as averaging or otherwise assigning a weighting factor to each of the various attributes associated with the created user personality profile and the received third-party personality profiles. Alternatively, the group personality profile may be limited to personality attributes that appear in more than one personality profile. This type of functionality may be useful for members of a social group who want to create a group personality where the common interests of the group are combined into a single personality such that the various members of the group may be able to enjoy portable communication device functionality, such as searching and/or sorting, with some assurance of receiving the same or similar result as other members of the social group. Optionally, the group personality (or any individual personalities discussed above or discussed herein with reference to the group personality) may include one or more mood indicators, e.g., indicators of a good mood, a happy mood, a sad mood, an angry mood or the like.

Optionally, at functional block 155, the portable communication device may receive input indicative of a particular mood. The received mood input may be indicative of the general mood of the group (in the case of a group personality) or the individual user's mood. For example, the group may be in a particular mood (good, bad or otherwise) and provide feedback for setting the group mood. It will be appreciated that the group mood may be determined in one of a number of ways consistent with that set forth above in connection with functional block 150. Alternatively, the user of the portable communication device may be in a particular good mood and enter input (e.g., by selecting one or more graphical representations or other indicators of moods, such as emoticonsm). Optionally, at functional block 160, the portable communication may adjust the personality profile (whether it be an individual profile or a group personality profile) based on the received mood input. For example, if the group or the individual user indicates a particularly good or happy mood, the portable communication device may modify or otherwise focus search and/or sort results to emphasize things associated with being in a good mood, such as upbeat songs, stories with a happy ending or the like. Alternatively, the group or individual user of the portable communication device may indicate a bad, negative, or otherwise sad mood, which in turn would alter the personality (whether it be an individual personality or a group personality) such that the ensuing search and/or sort results would be changed.

For example, the portable communication device may engage in a music search, based on criteria independent of mood. In response to receiving user input indicative of a certain mood, the portable communication device may alter or re-sort the search results to emphasize results that are particularly compatible with the given mood entered by the user of the portable communication device.

Turning now to FIG. 7, a method of commercial operation involving celebrity's personality profiles is provided. At functional block 200, one or more celebrity personality profiles may be created. As used herein, “celebrity” is meant to include personality profiles associated with well-known individuals, such as musicians, actors, actresses, professional athletes, politicians and the like. Alternatively, “celebrity” may include profiles associated with given demographics, e.g., “the twenty-one year old male”, the fourteen year old female”, “the fifty year old stock broker”, “the typical UCLA college student” or the like. It will be appreciated that creation of these celebrity personality profiles may be accomplished directly using a portable communication device associated with a celebrity or may be created, for example, by a celebrity completing a series of questions, which result in a creation of a personality profile.

At functional block 210, the provider of the celebrity personality profiles may receive a request for one or more of celebrity personality profiles. For example, the user of the portable communication device may be a big fan of LeBron James, such that the user of the device would enjoy having “LeBron's phone,” meaning that personality profile attributes associated with LeBron James could be transferred to a user's phone such that the user may experience things through his/her phone consistent with the way LeBron James experiences things using LeBron's phone. The request may be placed via direct contact or using the portable communication device, via the Internet or via any other suitable means for placing an order or otherwise indicating a desire to make a purchase. Alternatively, phones may be commercially offered with one or more personality profiles preloaded into the phones. At functional block 220, a celebrity personality profile database may be accessed and may upload a given personality profile to the purchaser's portable communication device. Of course, other commercial variations making use of celebrities or demographic personality profiles may be implemented without departing from the scope of the present invention.

It will be appreciated that a portable communication device equipped with personality profile creation and sharing functionality allows user's to share their personal portable communication device experiences. Further, the provision of personality creation and sharing allows for the creation of group profiles and the enjoyment of celebrity profiles.

As will be appreciated by one of skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a memory; and
a controller coupled to the memory, wherein when the controller executes a user personality profile application program stored on a machine-readable medium, wherein when the user personality profile application program is loaded in memory and executed causes the portable communication device to:
create a user personality profile based on user activities and user preferences involving the portable communication device; and
transmit the user personality profile to a remote location.

2. The portable communication device of claim 1, wherein the remote location is a third-party portable communication device.

3. The portable communication device of claim 2, wherein the user personality profile is configured to affect searching and/or sorting functionality associated with the third-party portable communication device.

4. The portable communication device of claim 1, wherein the portable communication device receives files indicative of third party personality profiles.

5. The portable communication device of claim 4, wherein the personality profile application program causes the portable communication device to create a group personality profile based on the received third-party personality profiles and the user personality profile.

6. The portable communication device of claim 5, wherein the group personality profile includes mood adjustability.

7. The portable communication device of claim 6, wherein when the portable communication device receives input indicative of mood, the personality profile application causes the portable communication device to adjust at least one attribute of the group personality profile based on the received mood input.

8. The portable communication device of claim 1, wherein the personality profile application causes the portable communication device to create the personality profile by tracking user activities based on the user's use of the portable communication device, wherein the user activities include (i) places visited by the user, (ii) events attended by the user, (iii) networks to which the user has connected via the portable communication device, and/or (iv) devices to which the user has connected via the portable communication device.

9. The portable communication device of claim 8, wherein tracking a user activity includes determining a location of an activity and/or a time and/or date of an activity

10. The portable communication device of claim 9, wherein a location of an activity is determined using a position determination device coupled to the portable communication device.

11. The portable communication device of claim 1, wherein the personality profile application causes the portable communication device to create the personality profile by tracking user preferences based on the user's use of the portable communication device, wherein the user preferences include (i) multimedia preferences, (ii) media playback preferences, (iii) menu settings, (iv) display settings, and/or (v) websites visited using the portable communication device.

12. The portable communication device according to claim 1, wherein the portable communication device is a mobile telephone.

13. A method of user personality profile management implemented on a portable communication device, the method comprising:
creating a user personality profile based on user activities and user preferences involving use of the portable communication device; and
sharing the user personality profile with a third party.

14. The method of claim 13, wherein the user personality profile is configured to affect searching and/or sorting functionality associated with the third-party portable communication device.

15. The method of claim 13, the method further comprising receiving one or more files indicative of third-party personality profiles.

16. The method of claim 15, further comprising creating a group personality profile based on the received third-party personality profiles and the user personality profile.

17. The method of claim 13, wherein the user personality profile includes mood adjustability, whereby at least one property of the user personality profile is adjusted based on received mood input.

18. A method of managing a user personality profile implemented on a portable communication device, the method comprising:
receiving a third-party personality profile;
receiving user input indicative of a search request or a sort request;
initiating a search and/or sort based on the received third-party personality profile; and
presenting search and/or sort results to a user of the portable communication device based on the third-party personality profile.

19. A method of enhancing use of a portable communication device, the method comprising:
creating a celebrity personality profile indicative of the celebrity's activities and the celebrity's preferences involving a portable communication device; and
offering the celebrity personality profile for purchase.

20. The method of claim 19, further comprising uploading the celebrity personality profile to a requesting portable communication device.
